(19) United States
(12) Patent Application Publication
(10) Pub. No.: US 2016/0029424 A1
(43) Pub. Date: Jan. 28, 2016

(54) DIRECT DEVICE-TO-DEVICE COMMUNICATIONS RADIO TECHNOLOGY SELECTION

(71) Applicant: NOKIA TECHNOLOGIES OY, Espoo (FI)

(72) Inventors: Zexian LI, Espoo (FI); Martti Johannes MOISIO, Klaukkala (FI); Mikko Aleksi UUSITALO, HELSINKI (FI); Osman Nuri Can YILMAZ, Espoo (FI)

(21) Appl. No.: 14/774,117

(22) PCT Filed: Mar. 25, 2013
(86) PCT No.: PCT/US13/33760

§ 371 Date: Sep. 9, 2015

(51) Int. Cl. H04W 76/02; H04W 8/00; H04W 24/10

(52) U.S. Cl. CPC H04W 76/023; H04W 24/10; H04W 8/005; H04W 88/04

(57) ABSTRACT

Methods and apparatus, including computer program products, are provided for providing, by a user equipment, information representative of one or more radio technologies available for use by a device-to-device radio interface at the user equipment; and receiving, by the user equipment, an indication representative of a selection of at least one of the one or more radio technologies for use by the device-to-device radio interface at the user equipment. Related apparatus, systems, methods, and articles are also described.

### FIELD

The subject matter disclosed herein relates to wireless communications, and, in particular, device-to-device communications.

### BACKGROUND

There are various types of networks, including infrastructure networks (e.g., the internet, cellular networks, and/or the like), ad-hoc networks, or a combination of both. In the case of the infrastructure network, the user equipment communicates (e.g., transmits and/or receives) with another user equipment through an access point, such as base station or a wireless access point. In the case of the ad-hoc network, the user equipment communicates directly with another user equipment. Ad hoc networks are also called “proximity services” (ProSe) and/or “device-to-device” (D2D) networks, referring to the wireless direct link(s) between a plurality of user equipment. In the case of ad-hoc, D2D communications, some of the D2D communications are also controlled by a base station, providing so-called “cellular controlled” D2D communications (which is also referred to as cellular assisted D2D communications). In cellular controlled D2D communications, two devices may be directly linked via a D2D connection, and the devices may be attached to a base station, such as an enhanced Node B (eNB) base station, to exchange control information with the eNB (or other nodes of the network).

### SUMMARY

Methods and apparatus, including computer program products, are provided for device-to-device communications radio technology selection.

In some example embodiments, there is provided a method. The method may include providing, by a user equipment, information representative of one or more radio technologies available for use by a device-to-device radio interface at the user equipment; and receiving, by the user equipment, an indication representative of a selection of at least one of the one or more radio technologies for use by the device-to-device radio interface at the user equipment.

In some variations, one or more of the featured disclosed herein including one or more of the following features can optionally be included in any feasible combination. The providing may further include providing the information representative of the one or more radio technologies in response to a request from at least one of the network or the user equipment. The providing may further include providing the information representative of the one or more radio technologies to a database accessible by the network. At least one measurement of one or more radio channels being considered for the device-to-device radio interface may be performed. The user equipment may receive at least one of a frequency for the device-to-device radio interface at the user equipment, a channel number for the device-to-device radio interface at the user equipment, or resource usage information on a link accessed by the device-to-device radio interface at the user equipment. A device-to-device link at the device-to-device radio interface may be established based on at least the received indication. A device-to-device link at the device-to-device radio interface may be configured with the selected radio technology, wherein the radio technology is selected, based on at least the received indication.

In some example embodiments, there is provided a method. The method may include receiving, by the apparatus, information representative of one or more radio technologies available for use by a device-to-device radio interface at a user equipment; and sending, by the apparatus, an indication representative of a selection of at least one of the one or more radio technologies for use by the device-to-device radio interface at the user equipment.

Articles are also described that comprise a tangibly embodied computer-readable medium embodying instructions that, when performed, cause one or more machines (for example, computers) to result in operations described herein. Similarly, apparatus are also described that can include a processor and a memory coupled to the processor. The memory can include one or more programs that cause the processor to perform one or more of the operations described herein.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example of a system in which radio technology selection is performed for device-to-device communications, in accordance with some example embodiments;

FIG. 2 depicts an example of a process for providing device-to-device user equipment capabilities to a network, in accordance with some example embodiments;

FIG. 3 depicts an example of a process for selecting radio technology to be used for device-to-device communications;

FIG. 4 depicts an example of an apparatus that may be used as a user equipment, in accordance with some example embodiments; and

FIG. 5 depicts an example of a base station, in accordance with some example embodiments.

Like labels are used to refer to same or similar items in the drawings.

### DETAILED DESCRIPTION

In device-to-device communications, direct links between devices, such as user equipment, can be established for communications between the devices. User equipment may perform some form of discovery to identify the other user equipment for device-to-device communications. Moreover, the user equipment may be a multi-mode radio, which refers to a user equipment configured with a plurality of radio technologies, such as for example cellular radio, wireless local area networks, and/or the like. Accordingly, the device-to-device communication links may be configured in accordance with a selected one of the plurality of radio technologies.

In some example embodiments, the subject matter disclosed herein relates to providing user equipment radio technology information to a network to enable a selection of a radio technology for a device-to-device communication link at the user equipment.

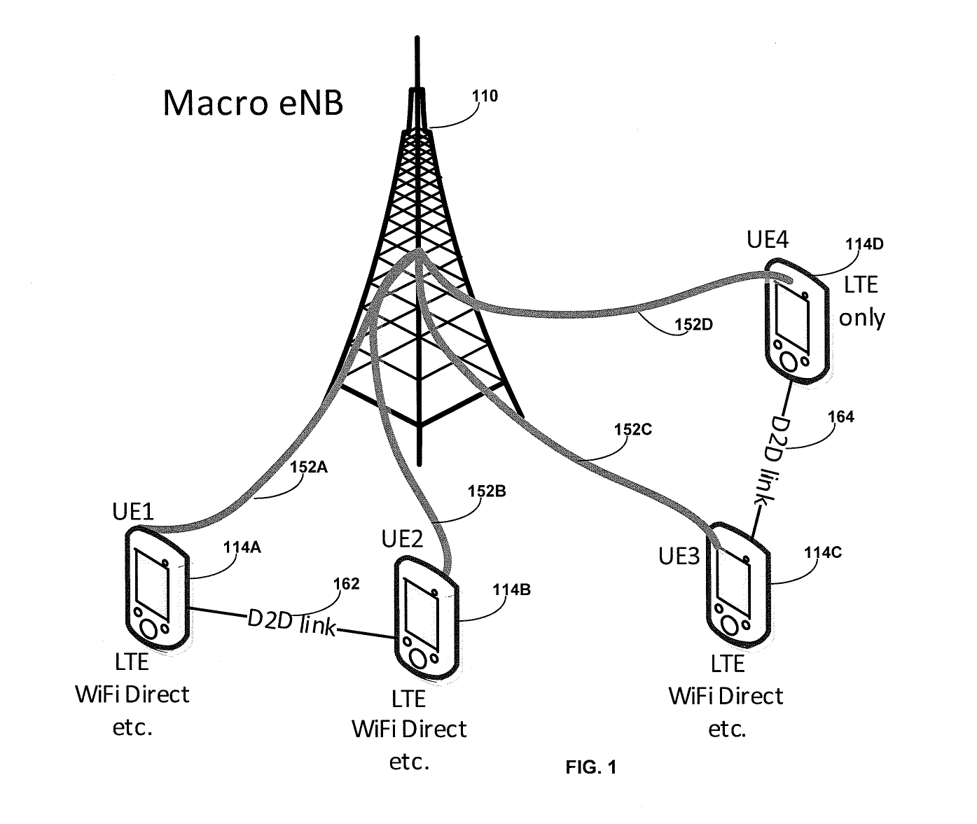

FIG. 1 depicts a system 100 including user equipment 114A-D coupled via links 152A-D to a base station 110, in accordance with some example embodiments. Links 152A-D may be configured in accordance with a cellular radio technology, such as LTE, although other radio technologies may be used as well. The user equipment may also be coupled via device-to-device communication links, such as links 162 and/or 164. These device-to-device communication links 162 and 164 may be configured directly between user equipment in accordance with a selected radio technology, such as LTE, WiFi direct, and/or other radio technologies for proximity communication as well.

In the example of FIG. 1, user equipment 114A and user equipment 114B can configure a device-to-device link using radio technologies, such LTE and/or WiFi direct or other radio technologies, common to user equipment 114A and 114B. In this example, the network including base station 110 may inform via link(s) 152A and/or 152B user equipment 114A-B to use either of these radio technologies to establish device-to-device communication link(s) 162 as both technologies are common and thus supported by user equipment 114A-B. In the case of user equipment 114C-D however, user equipment 114C includes an LTE configured radio interface and a WiFi direct radio interface, but user equipment 114D includes a WiFi direct radio interface, so the network including base station 110 may select and inform via link(s) 152C and/or 152D user equipment 114C-D to configure device-to-device communication link(s) 164 in accordance with LTE since, in this example, the only common shared radio technology between user equipment 114C and user equipment 114D is LTE.

Although some of the examples described herein refer to the user equipment having certain radio technologies, other radio technologies may be used as well. Moreover, although some of the examples described taking into account user equipment capability to determine which radio technology to select for device-to-device communications, other factors, such as link quality and the like, may be taken account to make the selection.

In some example embodiments, a user equipment may report to the network which device-to-device radio technologies are supported by the user equipment. For example, user equipment 114A may, in some example embodiments, provide to base station 110 via link(s) 152A information representative of the device-to-device radio technologies supported by user equipment 114A. Moreover, this device-to-device radio technology information may be provided during user equipment's 114A initial access procedure to the network including base station 110, as part of the initiation by user equipment 114A of the establishment of device-to-device services with for example user equipment 114B, and/or other times as well. Moreover, the current configuration of the device may be taken into account when selecting a radio technology. For example, if a WiFi radio interface at the user equipment is actively being used for a purpose other than a WiFi direct communication link and the user equipment only includes a single WiFi radio interface, WiFi direct, in this example, cannot be selected for device-to-device communication.

In some example embodiments, the device-to-device radio technology information sent by a user equipment to the network/base station may provide an indication of which radio technologies are supported by the user equipment in addition to a default radio technology. For example, user equipment 114A may provide to base station 110 device-to-device radio technology information indicative a wireless local area network technology, such as WiFi direct and/or the like, being supported, but the message carrying the device-to-device radio technology information may not, in some example embodiments, include information representative of LTE support at user equipment 114A as that may be considered a default radio technology.

In some example embodiments, the device-to-device radio technology supported or used by one or more user equipment may be stored in a database. This database may be maintained by, for example, a wireless network service provider and/or any other entity. And, the device-to-device radio technology information contained in the database may be gathered when, for example, each user equipment accesses the service provider's wireless mobile network, although the device-to-device radio technology information may be gathered at other times as well (for example, when the user equipment is initially purchased and/or the like).

In some example embodiments, the network may request user equipment 114A to make measurements of channel conditions for a device-to-device link. For example, base station 110 may send a message to user equipment 114A via link(s) 152A to measure the conditions of the radio channel(s) for a proposed device-to-device link 162, and/or base station 110 may send a message to user equipment 114B via link(s) 152B to measure the conditions of the radio channel(s) for a proposed device-to-device link 162, and these measurements may be used by the network or the user equipment for other purposes and radio technologies as well. Furthermore, the request to make measurements of a device-to-device link may also include information indicating the specifics of the device-to-device resources being considered for use. For example, the request sent by the network may inform user equipment 114A and/or 114B of one or more parameters, such as a frequency to be used for device-to-device link 162, a current configuration of the user equipment (for example, radio interfaces, such as transceivers, available for use and the like), a channel number for the device-to-device link 162, a resource block(s) to be accessed on device-to-device link 162, a radio technology to be used to access device-to-device link 162, and/or the like. And, these parameters provided by the network to user equipment 114A may vary based on the radio technology being used at device-to-device link 162.

In some example embodiments, the radio channel measurements made with respect to the device-to-device link 162 may then be reported back to the network including base station 110. For example, user equipment 114A and/or 114B may report device-to-device link 162 measurements made on the device-to-device link 162 and send those measurements to the network including base station 110 via link 152A-B, which in some example embodiments may be configured in accordance with a cellular radio technology, such as LTE and/or the like.

In some example embodiments, the network including base station 110 may select a radio technology and/or inform the user equipment to use a selected radio technology for the device-to-device link, although this selection may be performed by other devices including the user equipment as well. The selection of certain radio technology for a device-to-device link may, as noted above, be based on a variety of factors including a capability of the user equipment, a measurement reporting of the radio channel for the device-to-device link, a user preference, a network operator policy, the availability of the radio technology (for example, whether a radio interface for device-to-device communication is available or not) and/or the like. In the example of FIG. 1, base station 110 may send via link 152A a message to user equipment 114A informing user equipment 114A that it should use device-to-device link 162 configured as a WiFi direct link to communicate with user equipment 114B. This message may include additional information, such as a channel number, a frequency, an identity of the other user equipment, and/or any other information which can be used to access the device-to-device link. And, base station 110 may send via link 152B a message to user equipment 114B informing user equipment 114B that it should use device-to-device link 162 configured as a WiFi direct link to communication with user equipment 114A.

Before providing additional details regarding system 100, the following provides additional description of an example framework for system 100.

The base station 110 may comprise a wireless access point, such as a cellular base station, an evolved Node B (eNB) type base station, and/or the like, with wired and/or wireless backhaul links to other networks and/or network nodes, such as for example, a mobility management entity, other base stations, a radio network controller, a core network, a serving gateway, a database containing radio technologies implemented at one or more user equipment, and/or the like. In some example embodiments, base station 110 may serve a cell, such as for example, a macrocell, although other types of base stations, access points, and/or cells may be implemented as well.

As noted, base station 110, may, in some example embodiments, be implemented as an evolved Node B (eNB) type base station, although other types of radio access technologies may be implemented as well. When the evolved Node B (eNB) type base station is used, base station 110 may be configured in accordance with standards, including the Long Term Evolution (LTE) standards, such as for example, 3GPP TS 36.201, Evolved Universal Terrestrial Radio Access (E-UTRA), Long Term Evolution (LTE) physical layer, General description, 3GPP TS 36.211, Evolved Universal Terrestrial Radio Access (E-UTRA), Physical channels and modulation, 3GPP TS 36.212, Evolved Universal Terrestrial Radio Access (E-UTRA), Multiplexing and channel coding, 3GPP TS 36.213, Evolved Universal Terrestrial Radio Access (E-UTRA), Physical layer procedures, 3GPP TS 36.214, Evolved Universal Terrestrial Radio Access (E-UTRA), Physical layer—Measurements Protocol specification, 3GPP TS 36.331, Technical Specification Group Radio Access Network, Evolved Universal Terrestrial Radio Access (E-UTRA), Radio Resource Control (RRC), and any subsequent additions or revisions to these and other 3GPP series of standards (collectively referred to as LTE standards). Base station 110 may also be configured to serve cells using a WLAN technology, such as for example, WiFi (for example, the IEEE 802.11 series of standards), as well as any other radio access technology capable of serving a cell.

In some example embodiments, user equipment 114A-D may be implemented as a mobile device and/or a stationary device. In some example embodiments, user equipment 114A-D may be implemented as a multi-mode user device configured to operate using a plurality of radio technologies. For example, user equipment 114A-D may be configured to operate using a plurality of radio access technologies including one or more of the following: Long Term Evolution (LTE), wireless local area network (WLAN) technology, such as for example, 802.11 WiFi and/or the like, Bluetooth, Bluetooth low energy (BT-LE), near field communications (NFC), and/or any other radio technology. Moreover, user equipment 114A-D may be configured to have established connections to base station 110 via links, such as links 152A-D (for example, uplinks and downlinks), and user equipment 114A-D may configure device-to-device links, such as links 162, 164 and/or the like, using one or more of a plurality of the radio technologies, which may be selected by the network.

Although FIG. 1 depicts a specific quantity and configuration of base stations and user equipment, other quantities and configurations may be implemented as well.

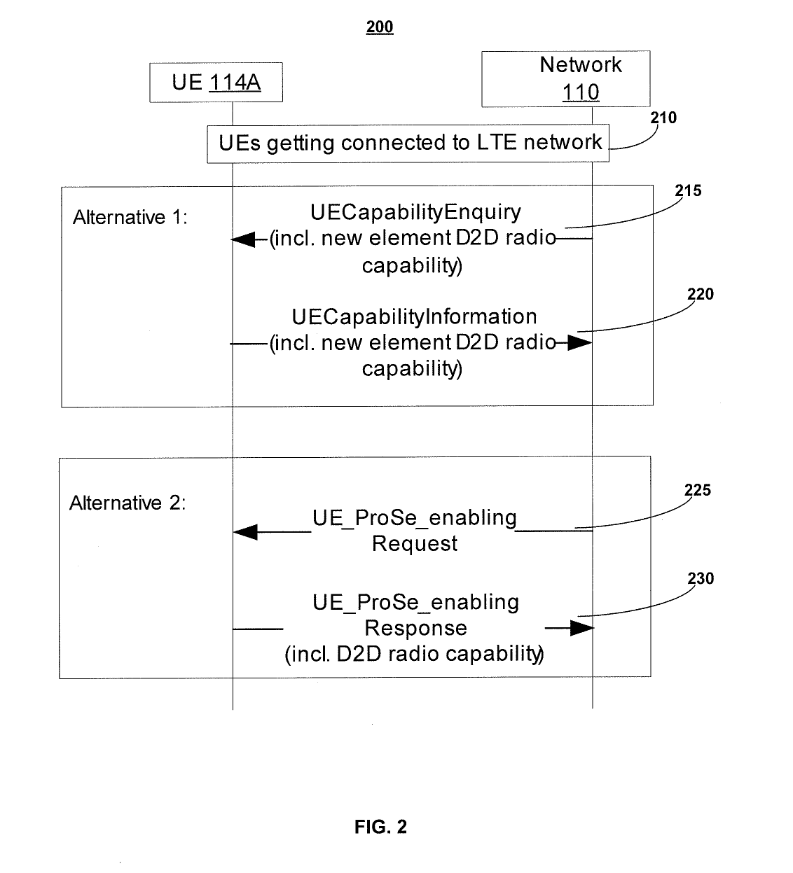

FIG. 2 depicts example processes 200 for providing to a network user equipment capability information including a user equipment's device-to-device radio technology capability, in accordance with some example embodiments.

In some example embodiments, user equipment 114A may access, at 210, and thus couple to a network including base station 110 using, for example, a radio technology, such as a cellular radio technology (for example, LTE and/or the like).

In some example embodiments, during an initial network access by the user equipment 114A, user equipment 114A may provide device-to-device capability information to network 110. Specifically, network 110 may send a message to a user equipment, such as user equipment 114A, to request, at 215, the device-to-device radio technology capability of user equipment 114A, in accordance with some example embodiments. In response, user equipment 114A may respond, at 220, to base station 110 with the device-to-device radio technology capability of user equipment 114A, in accordance with some example embodiments. For example, user equipment 114A may respond to base station 110 with a message indicating device-to-device radio technology support (as well as a current availability of those radio technology at the user equipment) of at least one of LTE, WiFi direct, and/or the like. The user equipment 114A may report its device-to-device capability information, without being requested by the network.

However, in some example embodiments, when either a user equipment, such as user equipment 114A, or a network, such as network/base station 110, initiates a device-to-device service, the network 110 may, at 225, request user equipment 114A to report its device-to-device radio technology capability, in accordance with some example embodiments. Device-to-device service may include one or more of a discovery service (for example, discovery of other devices for device-to-device communications), a communication service (for example, an actual device-to-device communication session), and/or any other device-to-device service. In response, user equipment 114A may respond, at 230, to base station 110 with the device-to-device radio technology capability of user equipment 114A, in accordance with some example embodiments. Moreover, when user equipment 114A initiates the device-to-device service, user equipment 114A may include the device-to-device capability information in a message, such as a device-to-device establishment message sent to the network 110.

In some example embodiments, network 110 may gather device-to-device radio technology capability information for one or more user equipment and store the information in a database for use by network 110. This information may allow the network 110 to select and/or inform a user equipment of which device-to-device radio technology to use when establishing a device-to-device radio link. For example, when user equipment 114A-D access network 110, network 110 may obtain the device-to-device radio capabilities for each of user equipment 114A-D (for example, as described at 215 and 220). This obtained information may then be stored in a database, which can be controlled by the mobile service provider and/or other entities as well. As such, when a device-to-device service is being established, the network 110 may access the database to identify and select a radio access technology for a device-to-device link, such as link 162, between user equipment 114A-B, so that the selected radio technology is compatible with each of the user equipment 114A-B.

Although the previous example describes a certain time when capability information is gathered, device-to-device radio technology capability information may be gathered for the database at other times as well (for example, during a handover as part of the user context delivered from one base station to another base station).

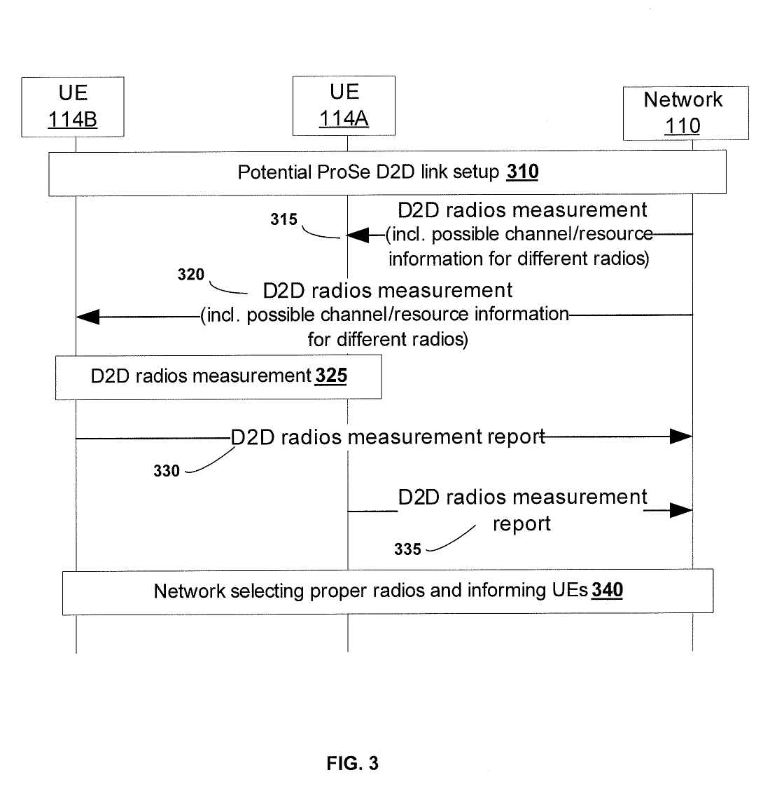

FIG. 3 depicts a process 300 for device-to-device radio selection in accordance with some example embodiments.

At 310, a device-to-device communication link (also referred to as proximity service (ProSe)) may be considered for establishment, in accordance with some example embodiments. For example, device-to-device links may be considered for set up at 162 and/or 164. And, this establishment may be at the initiation by the user equipment 114A-D and/or network/base station 110.

At 315, the network 110 may send a message via link 152A to user equipment 114A to perform radio measurements of device-to-device link 162, in accordance with some example embodiments. In some example embodiments, this request may also include one or more of the following: a frequency to be used for device-to-device link 162, a channel number for device-to-device link 162, a resource block(s) to be accessed on device-to-device link 162, a radio technology to be used for device-to-device link 162, and/or the like. The link 152A may include one or more of an uplink and a downlink configured in accordance with a radio technology and, in particular, a cellular radio technology, such as LTE and/or the like, rather than a wireless local area network technology, such as WiFi and/or WiFi direct.

At 320, network 110 may also send via link 152B a message to user equipment 114B to perform radio measurements related to device-to-device link 162. This request may also include a frequency to be used for device-to-device link 162, a channel number for device-to-device link 162, a resource block(s) to be accessed on device-to-device link 162, a radio technology to be used for device-to-device link 162, types of measurements to be made, and/or the like. The link 152B may include one or more of an uplink and a downlink configured in accordance with a radio technology and, in particular, a cellular radio technology, such as LTE and/or the like, rather than a wireless local area network technology, such as WiFi direct.

At 325, user equipment 114A-B may perform radio measurements of the proposed device-to-device link 162 between user equipment 114A-B. The radio measurements may provide an indication of the quality of one or more radio channels being considered to carry a device-to-device link 162 configured with a selected radio technology.

At 330 and 335, user equipment 114A-B may report via links 152A-B the results of the radio measurements performed at 325 to network/base station 110. The network may then select a radio technology for the device-to device link 162 based on at least the measurements reported at 330 and 335, radio technology capabilities/configuration of user equipment 114A-B, a user preference, a network operator policy, a type of traffic to be carried by device-to device link 162, an anticipated traffic volume at device-to device link 162, a certain quality of service (QoS), and/or the like. Although the previous example describes selection being performed by the network, radio technology selection may be performed by other devices as well, in which case the network may still inform the user equipment of the selection.

At 340, the network may select a radio technology for device-to-device link 162 and inform user equipment 114A-B of the selected radio technology to be used for the device-to-device link 162, in accordance with some example embodiments. For example, the device-to-device radio technologies of user equipment 114A-B include LTE and WiFi direct. Moreover, the measurement reported at 114A-B may indicate that either technology may be used, while user preference and network policy may also indicate a preference for WiFi direct. In this example, at 340, the network may select WiFi direct as the radio technology for device-to-device link 162 and then inform user equipment 114A-B of the selection in accordance with some example embodiments. Next, a device-to-device link 162 may be established between user equipment 114A-B to allow transmission and reception in accordance with the selected radio technology.

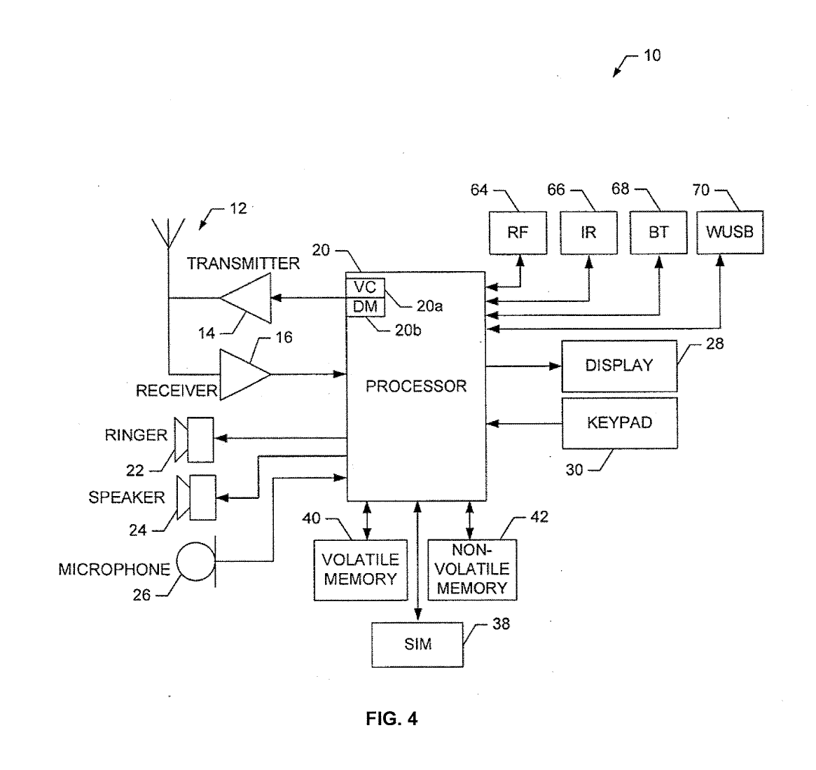

FIG. 4 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example, a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 4 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the apparatus 10 may be capable of operating in accordance with 2.5G wireless communication protocols General Packet Radio Service. (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example, LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example, location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 4, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example, an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example, within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example, IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as for example, an international mobile equipment identification (IMEI) code, capable of uniquely identifying apparatus 10. The functions may include one or more of the operations disclosed herein with respect to the user equipment, such as for example, the functions disclosed at process 200 (for example, activate the cellular modem and/or the like). The memories may comprise an identifier, such as for example, an international mobile equipment identification (IMEI) code, capable of uniquely identifying apparatus 10. In the example embodiment, the processor 20 may be configured using computer code stored at memory 40 and/or 42 to enable generation of messages including the radio technology capabilities of the apparatus and configuration of a device-to-device link in accordance with a selected radio technology for a device-to device link from the apparatus to another apparatus.

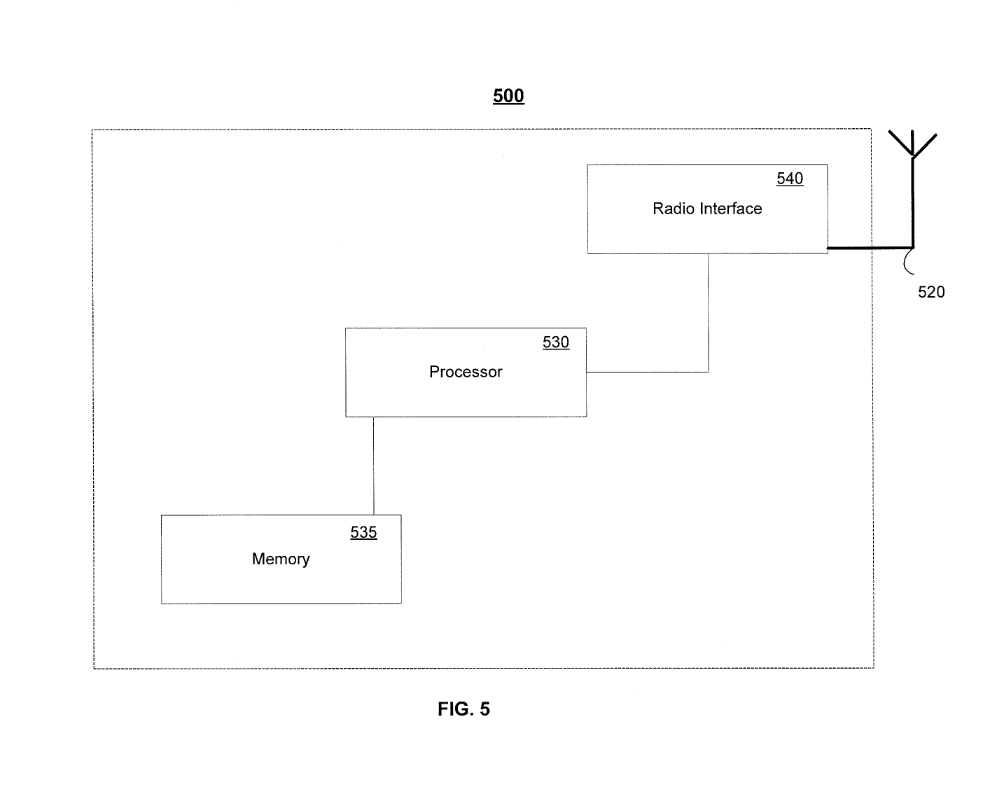

FIG. 5 depicts an example implementation of a network node, such as a base station 110. The base station may include one or more antennas 520 configured to transmit via a downlink and configured to receive uplinks via the antenna(s) 520. The base station may further include a plurality of radio interfaces 540 coupled to the antenna 520. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 540 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). The base station may further include one or more processors, such as processor 530, for controlling the access point 500 and for accessing and executing program code stored in memory 535. In some example embodiments, the memory 535 includes code, which when executed by at least one processor causes one or more of the operations described herein with respect to a base station. For example, the base station may receive, from the user equipment, information representative of one or more radio technologies available for use by a device-to-device radio interface a user equipment, send to the user equipment an indication representative of a selection of at least one of the one or more radio technologies for use by the device-to-device radio interface at the user equipment, and/or provide any other operations associated with the network or base station disclosed herein.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example, a computer or data processor, with examples depicted at FIGS. 4 and 5. A computer-readable medium may comprise a non-transitory computer-readable storage medium that may be any media that can contain or store the instructions for use by or in connection with an instruction execution system, apparatus, or device, such as for example, a computer. And, some of the embodiments disclosed herein include computer programs configured to cause methods as disclosed herein (see, for example, process 200, 300, and/or the like).

Without in any way limiting the scope, interpretation, or application of the claims appearing below, a technical effect of one or more of the example embodiments disclosed herein is providing a selected radio technology for a device-to device link between user equipment, wherein the selected radio technology is selected in order to avoid detracting from a user's experience.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1-21. (canceled)

22. A method comprising:
providing, by a user equipment, information representative of one or more radio technologies available for use by a device-to-device radio interface at the user equipment; and
receiving, by the user equipment, an indication representative of a selection of at least one of the one or more radio technologies for use by the device-to-device radio interface at the user equipment.

23. The method of claim 22, wherein the providing further comprises:
providing the information representative of the one or more radio technologies, in response to a request from at least one of the network or the user equipment.

24. The method of claim 22, wherein the providing further comprises:
providing the information representative of the one or more radio technologies to a database accessible by the network.

25. The method of claim 22 further comprising:
performing at least one measurement of one or more radio channels being considered for the device-to-device radio interface.

26. The method of claim 22 further comprising:
receiving, by the user equipment, at least one of a frequency for the device-to-device radio interface at the user equipment, a channel number for the device-to-device radio interface at the user equipment, a resource usage information for a link to be accessed by the device-to-device radio interface at the user equipment.

27. The method of claim 22 further comprising:
establishing, based on at least the received indication, a device-to-device link at the device-to-device radio interface.

28. The method of claim 22 further comprising:
configuring, with the selected radio technology, a device-to-device link at the device-to-device radio interface, wherein the radio technology is selected, based on at least the received indication, by the network.

29. An apparatus, comprising:
at least one processor; and
at least one memory including computer program code, the at least one memory and the computer program code configured to, with the at least one processor, cause the apparatus to perform at least the following:
provide information representative of one or more radio technologies available for use by a device-to-device radio interface at the apparatus; and
receiving an indication representative of a selection of at least one of the one or more radio technologies for use by the device-to-device radio interface at the apparatus.

30. The apparatus of claim 29, wherein the apparatus is further caused to at least provide the information representative of the one or more radio technologies, in response to a request from at least one of the network or the apparatus.

31. The apparatus of claim 29, wherein the apparatus is further caused to at least provide the information representative of the one or more radio technologies to a database accessible by the network.

32. The apparatus of claim 29, wherein the apparatus is further caused to at least perform at least one measurement of one or more radio channels being considered for the device-to-device radio interface.

33. The apparatus of claim 29, wherein the apparatus is further caused to at least receive at least one of a frequency for the device-to-device radio interface at the apparatus, a channel number for the device-to-device radio interface at the apparatus, or a resource usage information for a link to be accessed by the device-to-device radio interface at apparatus.

34. The apparatus of claim 29, wherein the apparatus is further caused to at least establish, based on at least the received indication, a device-to-device link at the device-to-device radio interface.

35. The apparatus of claim 29, wherein the apparatus is further caused to at least configure, with the selected radio technology, a device-to-device link at the device-to-device radio interface, wherein the radio technology is selected, based on at least the received indication, by the network.

36. An apparatus, comprising:
at least one processor; and
at least one memory including computer program code, the at least one memory and the computer program code configured to, with the at least one processor, cause the apparatus to perform at least the following:
receive, from a user equipment, information representative of one or more radio technologies available for use by a device-to-device radio interface at the user equipment; and
send, to the user equipment, an indication representative of a selection of at least one of the one or more radio technologies for use by the device-to-device radio interface at the user equipment.

37. The apparatus of claim 36, wherein at least one of a base station or another user equipment performs at least one of the receiving or the sending.
